(19) United States
(12) Patent Application Publication
(10) Pub. No.: US 2015/0224449 A1
(43) Pub. Date: Aug. 13, 2015

(54) METHOD OF PROCESSING BLACK LIQUOR

(71) Applicant: New Century Membrane Technology Co., Ltd., Taichung City (TW)

(72) Inventor: Chi-Chang Kuo, Taichung City (TW)

(73) Assignee: New Century Membrane Technology Co., Ltd., Taichung City (TW)

(21) Appl. No.: 14/180,317

(22) Filed: Feb. 13, 2014

(51) Int. Cl. B01D 65/02; B01D 63/16; C02F 1/44

(52) U.S. Cl. CPC B01D 65/02; C02F 1/444; C02F 1/442; C02F 1/441; B01D 63/16

(57) ABSTRACT

A method of processing black liquor contains steps of: A. flowing waste black liquor, chemically boiled, into a treatment tank; B. aerating and floating the waste black liquor in the treatment tank so as to eliminate macromolecule staple fibers and solids; C. solid-liquor separating the waste black liquor which passes through a plurality of circularly flat UF membranes by means of vacuum pressure difference; D. periodically scrapping adhesive layers on the plurality of circularly flat UF membranes when the plurality of circularly flat UF membranes rotate; E. concentrating the treated water which flows through plural rear UF membranes by a NF membrane to produce recycling lye for producing paper pulp and recyclable concentrated black liquor with high concentrations of lignin.

### FIELD OF THE INVENTION

The present invention relates to a method of processing papermaking wastewater and equipment therefor, and more particularly to a method of processing black liquor and equipment therefor which lowers operation cost in papermaking and recycles lye and concentrated black liquor.

### BACKGROUND OF THE INVENTION

Black liquor is one of pollution sources in papermaking industry, wherein at least 90% of pollutants in pulp manufacturing process come from COD and BOD, and 70% of solids in black liquor are organic compounds, inclusive of lignin, polysaccharides, humic acid and cellulose degradations. In addition, 30% of solids are inorganic substances, including the free salt (base) and compounds containing silicon.

Typically, the black liquor is processed by means of a lye recycling method, wherein the lye recycling method contains dehydrating the black liquor by ways of an evaporator so as to produce concentrated black liquor. Due to lignin and hemicellulose exist in concentrated black liquor at high proportion, they are burned by an alkali recovery boiler so as to become ashes with Na₂Co₃, and water is added to ashes to produce green liquid with small amount of iron ions, and then slaked lime is added to have recausticizing, thus generating NaOH. Finally, NaOH is recycled and used in pulp cooking process.

However, the evaporator is driven by burning coals to cause high production cost and to burn valued organics (such as lignin, turpentine, and saponified substances.

A membrane separation is served to recycle lignin in the black liquor, wherein lignin and solids are maintained by filtration membranes at a certain pressure so as to lower COD and BOD in liquor. Nevertheless, content of the solids in the black liquor is high and sticky, so filtrate liquidity decreases quickly and concentration increases to block the filtration membrane, thereby lowering recycle efficiency of lignin and increasing production cost.

The present invention has arisen to mitigate and/or obviate the afore-described disadvantages.

### SUMMARY OF THE INVENTION

The primary object of the present invention is to provide a method of processing black liquor which removes solids from UF membranes by ways of aeration disturbing, shear force resulting from rotating the UF membranes, and periodically scrapping the UF membranes, hence the UF membranes are not blocked so as to prolong service life and to decrease using cost of the UF membranes.

Another object of the present invention is to provide an equipment of processing black liquor which prevents the UF membranes from obstruction and prolongs service life of the UF membranes.

To obtain the above objective, a method of processing black liquor contains steps of:

A. flowing waste black liquor, which is chemically boiled, into a treatment tank, wherein the treatment tank has at least one rotary flat membrane unit formed in a circle shape and disposed in the treatment tank;

B. aerating and floating the waste black liquor in the treatment tank so as to eliminate macromolecule staple fibers and solids;

C. solid-liquor separating the waste black liquor which passes through a plurality of circularly flat UF membranes by means of vacuum pressure difference so that organic solids in the waste black liquor are remained in the treatment tank, and permeating liquor passing through the plurality of circularly flat UF membranes forms treated water;

D. periodically scrapping adhesive layers on the plurality of circularly flat UF membranes when the plurality of circularly flat UF membranes rotate so as to remove the solids and colloidal from the plurality of circularly flat UF membranes;

E. concentrating the treated water which flows through plural rear UF membranes by ways of a NF membrane so as to produce recycling lye for producing paper pulp and recyclable concentrated black liquor with high concentrations of lignin.

Also, an equipment of processing black liquor provided by the present invention contains:

a treatment tank which is an open tank for receiving waste black liquor for producing paper pulp;

at least one rotary flat membrane unit formed in a circle shape and horizontally soaked in the treatment tank, each rotary flat membrane unit having a plurality of circularly flat UF membranes equidistantly formed thereon and a water tube arranged along central positions of the plurality of circularly flat UF membranes, wherein the water tube is driven by a power unit to rotate, and a vacuum pressure difference facilitates the waste black liquor to be solid-liquor separated through the plurality of circularly flat UF membranes so as to form treated water, thereafter the treated water is flowed into the water tube by a vacuum pump;

an ultrafiltration tank mounted behind the at least one rotary flat membrane unit and communicating with the water tube so as to collect the treated water;

a scraping unit including plural rotating disks connected with the plurality of circularly flat UF membranes, a plurality of brushers radially extending outwardly from the plural rotating disks, and plural stop bars corresponding to the plurality of brushers, wherein each brusher contacts with the plurality of circularly flat UF membranes, when the plurality of circularly flat UF membranes rotate with the water tube, the plurality of brushers are stopped by the plural stop bars so that the plurality of brushers scrap the plurality of circularly flat UF membranes;

a NF membrane unit fixed behind the ultrafiltration tank so as to produce recycling lye and recyclable concentrated black liquor.

### BRIEF DESCRIPTION OF THE DRAWINGS

FIG. 1 is a block flow diagram of a method of processing black liquor and equipment therefor according to a preferred embodiment of the present invention.

FIG. 2 is a diagram showing the assembly of an equipment of processing black liquor according to the preferred embodiment of the present invention.

FIG. 3 is a diagram showing the operation of the equipment of processing black liquor according to the preferred embodiment of the present invention.

FIG. 4 is a cross sectional view showing the operation of the equipment of processing black liquor according to the preferred embodiment of the present invention

FIG. 5 is also a diagram showing the operation of the equipment of processing black liquor according to the preferred embodiment of the present invention.

### DETAILED DESCRIPTION OF THE PREFERRED EMBODIMENTS

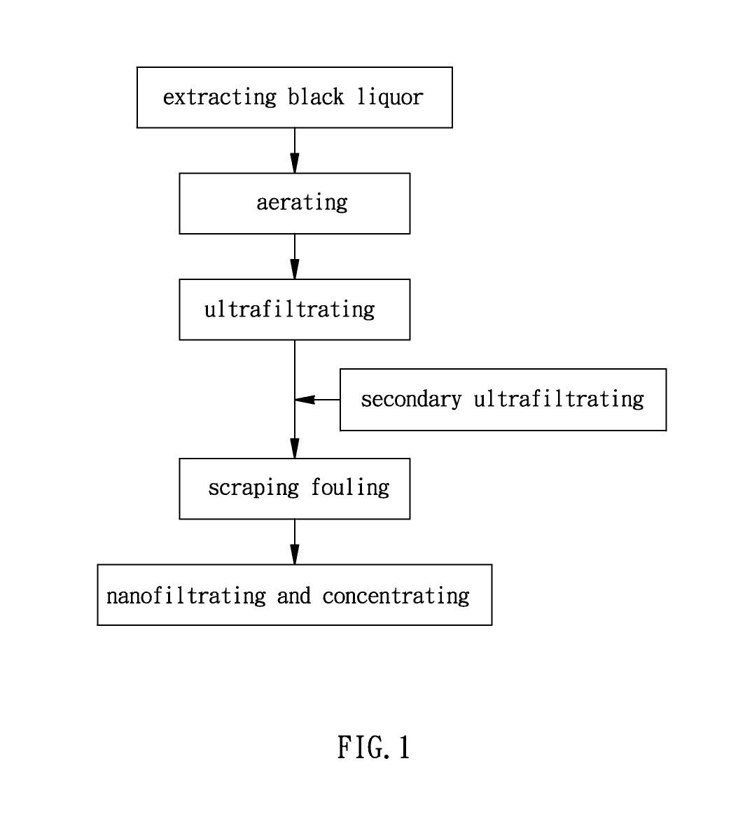

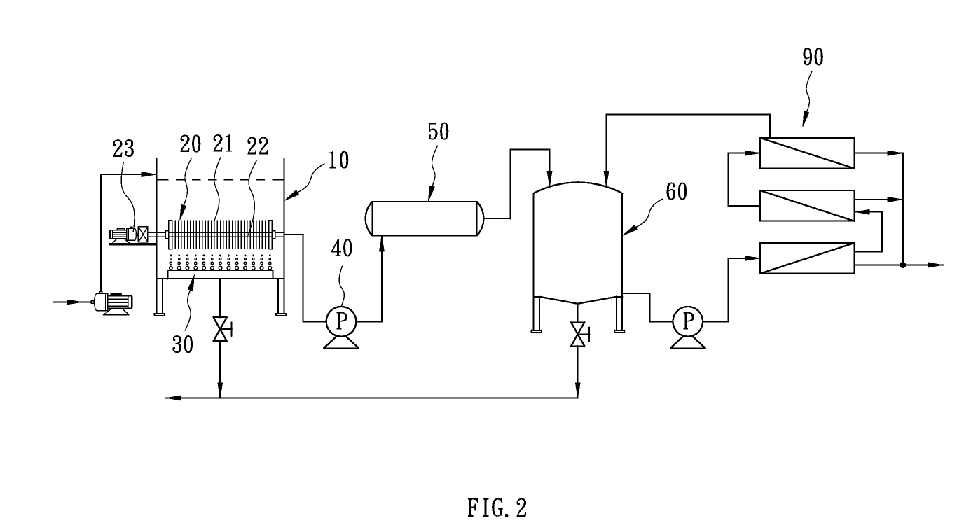

With reference to FIGS. 1 and 2, a method of processing black liquor and equipment therefor according to a preferred embodiment of the present invention contains steps of:

A. Flowing waste black liquor, which is chemically boiled, into a treatment tank 10, wherein the treatment tank 10 has an open top surface, at least one rotary flat membrane unit 20 formed in a circle shape and disposed in the treatment tank 10, and an aeration unit 30 mounted on a bottom end of the treatment tank 10. Each rotary flat membrane unit 10 does not have a cover and is a horizontally open structure (i.e., an open flat membrane plate) soaked in the treatment tank 10. Also, each rotary flat membrane unit 20 has a plurality of circularly flat UF membranes 21 equidistantly formed thereon and a water tube 22 arranged along central positions of the plurality of circularly flat UF membranes 21.

B. Aerating and floating the waste black liquor by ways of the aeration unit 30, wherein the aeration unit 30 sprays pressurized microbubbles so as to eliminate macromolecule staple fibers and solids and to aerate and stir the plurality of circularly flat UF membranes 21. Moreover, in an aeration treatment, the plurality of circularly flat UF membranes 21 is driven by a power unit 23 (such as a motor) to rotate, and the power unit 23 is fixed on one end of the water tube 22, such that the water tube 22 and the plurality of circularly flat UF membranes 21 rotate concentrically so as to form a shear flow for scrubbing the plurality of circularly flat UF membranes 21, thus decreasing a growth of a gel layer (i.e., a filter cake) on surfaces of the plurality of circularly flat UF membranes 21 and maintaining water flux of the plurality of circularly flat UF membranes 21.

C. Ultrafiltrating the waste black liquor in the treatment tank 10 by means of two-stage ultrafiltration membrane separations, wherein a first-stage ultrafiltration membrane separation is used to process the plurality of circularly flat UF membranes 21 in the treatment tank 10, for example, the water tube 22 is vacuumed by a vacuum pump 40 so as to generate vacuum pressure difference, such that the waste black liquor is solid-liquor separated through the plurality of circularly flat UF membranes 21, and organic solids (such as lignin, free silica) in the waste black liquor are remained in the treatment tank 10, then permeating liquor passing through the plurality of circularly flat UF membranes 21 is flowed into a rear ultrafiltration unit 50 outside the treatment tank 10 via the water tube 22, thereafter the permeating liquor is membrane separation concentrated by using a water pump 40 and is flowed into an ultrafiltration tank 60 from the rear ultrafiltration unit 50.

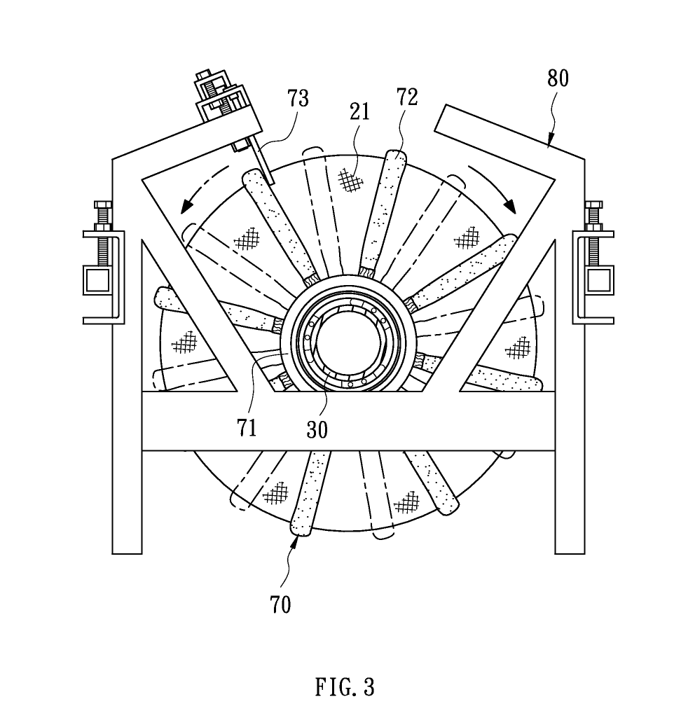

D. Periodically scrapping adhesive layers on the plurality of circularly flat UF membranes 21 when the plurality of circularly flat UF membranes 21 rotate so as to remove the solids and colloidal from the plurality of circularly flat UF membranes 21. Referring to FIG. 3, means for scraping the plurality of circularly flat UF membranes 21 is executed by a scraping unit 70. The scraping unit 70 includes plural rotating disks 71 connected with the plurality of circularly flat UF membranes 21, a plurality of brushers 72 radially extending outwardly from the plural rotating disks 71, and plural stop bars 73 corresponding to the plurality of brushers 72, wherein each brusher 72 is made of any one of rubber, sponge and staple material and contacts with the plurality of circularly flat UF membranes 21. The plural stop bars 73 are mounted on a bracket 80 above the treatment tank 10 and are driven by a programmable logic controller (PLC), such that when the plurality of circularly flat UF membranes 21 rotate with the water tube 22, and the plurality of brushers 72 contacts with the plural stop bars 73, the plural stop bars 73 intermittently stop the plurality of brushers 72 so that the plurality of brushers 72 scrap the plurality of circularly flat UF membranes 21, thus removing solids and colloidal from the plurality of circularly flat UF membranes 21.

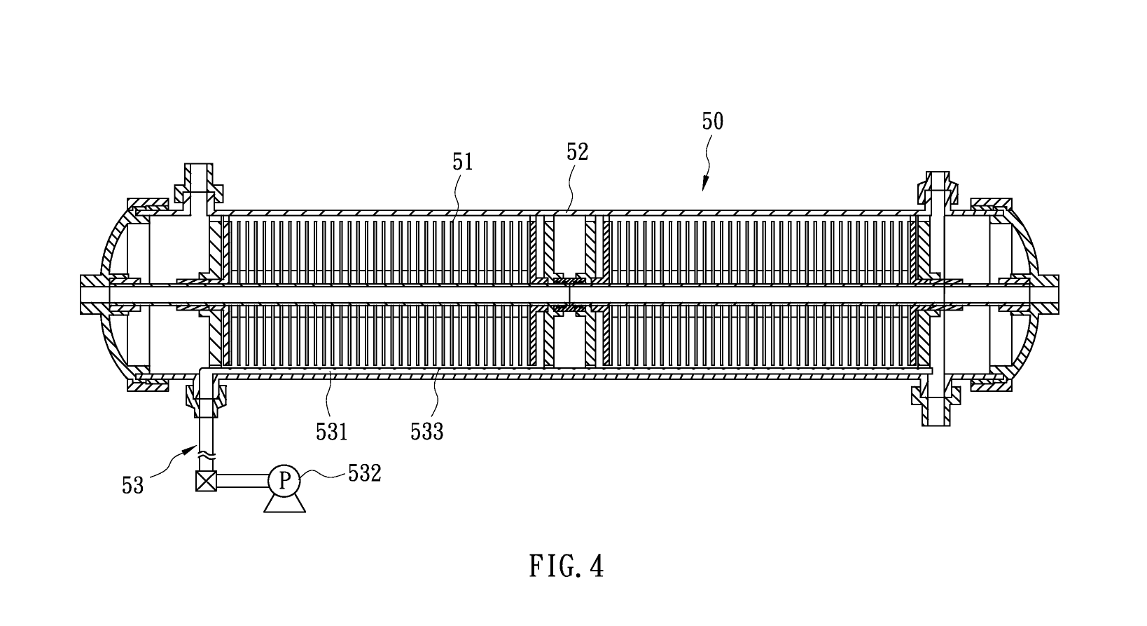

As shown in FIG. 4, in order to prolong a service life of plural rear UF membranes 51, a membrane pipe 52 closes the plural rear UF membranes 51 and has a spraying unit 53 disposed on an inner wall thereof. The spraying unit 53 has a water spray hose 531 corresponding to the plural rear UF membranes 51. After starting an air pump 532, high-pressure air are pumped into the membrane pipe 52 from an aeration inlet of the water spray hose 531 so as to wash plural ultrafiltration membrane bags. Since related washing operation process was taught by the applicant in TW Patent No. I 348389, further remarks are omitted herein.

It is to be noted that 80% of solids in the waste black liquor are remained by/on the plurality of circularly flat UF membranes 21, the plural rear UF membranes 51 will not be obstructed, thus eliminating membrane scrapping process to the plural rear UF membranes 51.

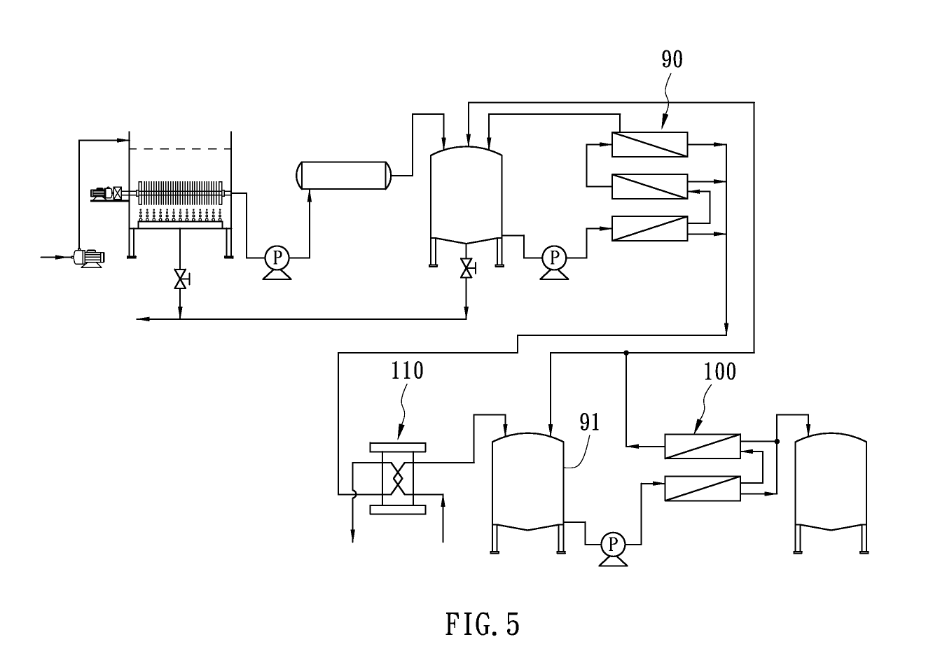

E. Concentrating treated water which flows through the plural rear UF membranes 51 by ways of a NF membrane of a NF membrane unit 90 (as illustrated in FIG. 5) so as to produce recycling lye for producing paper pulp and recyclable concentrated black liquor with high concentrations of lignin. The concentrated black liquor is mixed with the solids filtered by the flat UF membranes 21 so as to extract lignin in the concentrated black liquor. In this embodiment, the lye can be stored in a nanofiltration tank 91.

Thereby, the method of processing black liquor and equipment therefor is applicable for concentrated black liquor in paper industry and is served to separate the lye from the waste black liquor so that the lye is made into the paper pulp. Furthermore, the concentrated black liquor contains high concentrations of lignin. The waste black liquor is ultrafiltrated and concentrated by means of aeration disturbing, shear force resulting from rotating the UF membranes, and periodically scrapping the UF membranes so as to remove solids and colloidal from the UF membranes, thereby enhancing turbidity resistance of the waste black liquor and preventing the UF membranes from obstruction.

Preferably, each rotary flat membrane unit does not have the housing and is a horizontally open structure so as to be cleaned by water without causing obstruction, thus prolonging its service life.

As illustrated in FIG. 5, filtered liquor, which is filtered and concentrated in a nanofiltration concentrating treatment of step E, is processed in a reverse osmosis membrane treatment, wherein a RO membrane unit 100 is applied to separate solids and liquor and is mounted behind the nanofiltration tank 91 of the NF membrane unit 90 so as to eliminate organic salinization and Chroma in the filtered liquor. To avoid the RO membrane being influenced by liquor temperature, a heat exchanger 110 is fixed before the RO membrane unit 100 so as to exchange heat with the filtered liquor, hence the filtered liquor is in compliance with water discharge standard or is recycled. In addition, carbohydrate is stopped by RO membrane so as to be reused (such as fermentation material made into alcohol).

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method of processing black liquor comprising steps of:
A. flowing waste black liquor, which is chemically boiled, into a treatment tank, wherein the treatment tank has at least one rotary flat membrane unit formed in a circle shape and disposed in the treatment tank;
B. aerating and floating the waste black liquor in the treatment tank so as to eliminate macromolecule staple fibers and solids;
C. solid-liquor separating the waste black liquor which passes through a plurality of circularly flat UF membranes by means of vacuum pressure difference so that organic solids in the waste black liquor are remained in the treatment tank, and permeating liquor passing through the plurality of circularly flat UF membranes forms treated water;
D. periodically scrapping adhesive layers on the plurality of circularly flat UF membranes when the plurality of circularly flat UF membranes rotate so as to remove the solids and colloidal from the plurality of circularly flat UF membranes;
E. concentrating the treated water which flows through plural rear UF membranes by ways of a NF membrane so as to produce recycling lye for producing paper pulp and recyclable concentrated black liquor with high concentrations of lignin.

2. The method of processing black liquor as claimed in claim 1, wherein in step B, the plurality of circularly flat UF membranes rotate so as to form a shear flow for scrubbing the plurality of circularly flat UF membranes.

3. The method of processing black liquor as claimed in claim 1, wherein filtered liquor, which is filtered and concentrated in a nanofiltration concentrating treatment of step E, is processed in a reverse osmosis membrane treatment.

4. The method of processing black liquor as claimed in claim 3, wherein before the reverse osmosis membrane treatment, a heat is exchanged with the filtered liquor so as to avoid RO membrane is influenced by liquor temperature.

5. The method of processing black liquor as claimed in claim 1, wherein in the step B, the waste black liquor in the treatment tank is ultrafiltrated by means of two-stage ultrafiltration membrane separations, wherein the plurality of circularly flat UF membranes are driven by the vacuum pressure difference, and the plural rear UF membranes are driven by water to execute membrane filtration process

6. An equipment of processing black liquor comprising:
a treatment tank, which is an open tank, used to receive waste black liquor for producing paper pulp;
at least one rotary flat membrane unit formed in a circle shape and horizontally soaked in the treatment tank, each rotary flat membrane unit having a plurality of circularly flat UF membranes equidistantly formed thereon and a water tube arranged along central positions of the plurality of circularly flat UF membranes, wherein the water tube is driven by a power unit to rotate, and a vacuum pressure difference facilitates the waste black liquor to be solid-liquor separated through the plurality of circularly flat UF membranes so as to form treated water, thereafter the treated water is flowed into the water tube by a vacuum pump;
an ultrafiltration tank mounted behind the at least one rotary flat membrane unit and communicating with the water tube so as to collect the treated water;
a scraping unit including plural rotating disks connected with the plurality of circularly flat UF membranes, a plurality of brushers radially extending outwardly from the plural rotating disks, and plural stop bars corresponding to the plurality of brushers, wherein each brusher contacts with the plurality of circularly flat UF membranes, when the plurality of circularly flat UF membranes rotate with the water tube, the plurality of brushers are stopped by the plural stop bars so that the plurality of brushers scrap the plurality of circularly flat UF membranes;
a NF membrane unit fixed behind the ultrafiltration tank so as to produce recycling lye and recyclable concentrated black liquor.

7. The equipment of processing black liquor as claimed in claim 6 further comprising a rear ultrafiltration unit secured between the at least one rotary flat membrane unit and the ultrafiltration tank so as to extract lignin in the waste black liquor.

8. The equipment of processing black liquor as claimed in claim 6 further comprising a RO membrane unit mounted behind the NF membrane unit.

9. The equipment of processing black liquor as claimed in claim 8 further comprising a heat exchanger fixed before the RO membrane unit.

10. The equipment of processing black liquor as claimed in claim 6, wherein the treatment tank has an aeration unit mounted on a bottom end thereof so as to spray pressurized microbubbles to the waste black liquor.
